(19) United States
(12) Patent Application Publication
(10) Pub. No.: US 2005/0262130 A1
(43) Pub. Date: Nov. 24, 2005

(54) Input data specification method and system in business-to-business integration

(76) Inventor: Krishna Mohan, Naperville, IL (US)

Correspondence Address: Mr. Krishna Mohan, 3528 Breitwieser Lane, Naperville, IL, 60564, US

(21) Appl. No.: 10/851,010

(22) Filed: May 21, 2004

(51) Int. Cl. G06F 17/00

(52) U.S. Cl. 707/102

(57) ABSTRACT

A method and system for creating input data by a second entity in compliance with specifications of a first entity by using a specification object provided by the first entity, wherein the input data is transferred from second entity to the first entity over a computer network. The specification object comprises exposed input data definition and private executable instructions and distributed to second entity as one or more computer files. A specification interface system is provided to the second entity that receives a processing request comprising identifier of the specification object and exposed input data instance from a first data processing system of second entity and creates generated input data by executing the specification object. The generated input data is sent to the first entity over the computer network.

### CROSS-REFERENCE TO RELATED APPLICATIONS

Not Applicable.

### STATEMENT REGARDING FEDERALLY SPONSORED RESEARCH OR DEVELOPMENT

Not Applicable.

### SEQUENCE LISTING OR PROGRAM

Not Applicable.

### BACKGROUND OF THE INVENTION

1. Field of the Invention

The present invention relates in general to the field of computerized business-to-business integration and enterprise application integration, and more particularly, to a method and system for providing executable input data document specification from one business entity to another.

2. Background of the Invention

Business-to-business integration (B2B) or enterprise application integration (EAI) between two business entities typically involve exchanging various business documents or data documents such as an invoice, purchase order, ship notice, payment advice and the like. Simply stated, a first business entity receives an input data or input data document such as invoice, purchase order and the like from one or more trading partners (second entities) over a computer network such as the Internet or VAN (value added network). These input data documents may be represented in various dialects of EDI or XML standard based format such as ANSI X12, EDI FACT, ChemXML, ebXML, Rosettanet and the like. In another type of business-to-business integration such as Web services, the first entity exposes application logic accessible by external entities over a computer network, where the application logic accepts an input data from external entities. For example, the first entity may expose a currency conversion web service that accepts from currency, to currency and amount as input data embedded in a SOAP (Simple Object Access Protocol) request from external entities.

Often, input data accepted by the first entity is associated with validation rules comprising syntactical (structural) and business (semantic) rules imposed on partners that need to be complied by partners in order to correctly process incoming request. Typically business documents such as invoice or purchases orders are complex in nature due to syntactic and business rules associated with them. Even though tremendous effort have been made in standardizing these documents, it's well-known that despite these efforts, specification and requirement of business documents (input data) differs from one company to another or even between different departments of a company due to various business requirements and changing business processes.

Document formats specified using industry standards such as various Extensive Manipulation Language (“XML”) dialects such as ChemXML, ebXML and Electronic Data Interchange (“EDI”) standards such as X12 and EDIFACT are very generic and wide in nature, since they try to incorporate all possible fields and values to satisfy wide user community. Due to this, the business document specification based on these standards tends to have several segments, fields and many possible valid values for these fields, wherein most of these segments and fields are optional or conditional. This variation essentially results in large potential formats and selections for any given business document. These variations along with changing business requirements from one business entity to other have together resulted in every business entity having to define its own specification for the business document.

Many B2B and EAI projects are costly to build and maintain because of aforementioned variations from one company to other. Any violation of syntactic and business rules during business-to-business electronic interchange can cause rejection of the document causing delays and financial loss for both business entities, directly impacting their bottom-line, in addition to increased cost of maintaining such systems, manual reconciliation, error correction and the like.

Many new technologies have emerged in the area of business-to-business integration to improve the interchange of documents between business entities and to reduce overall cost. However, many of them focus on the “after the fact” details like reducing the effort of mapping from source data format to target data format and not on the heart of the problem itself—the area of specifying business-to-business document interchange requirements and imposing associated rules from one business entity to another—and this area needs improvement.

As explained in following prior-art section, current business-to-business integration specification methods tend to create tightly coupled, time consuming and labor intensive process around B2B and EAI area and needs improvement. It's proven by now in the industry that it is very hard for one standard agency or one electronic marketplace to force a data interchange format on companies. This is because most of the data elements of data interchange format are driven by business process of the company and is included in the document specification for a valid reason and companies are reluctant to change the business processes in order to fit into a standard specification. On the other hand, standard agencies or market places keep expanding allowed segments and data fields of a document specification to satisfy wide user community, making the standards very generic, leaving each business entity to define their “subset” of standards and associated business rules. Typically, large organizations define these formats and provide to their business partners to implement.

### PRIOR-ART

In order to better understand the benefits of current invention and limitation of prior-art of input data specification, reference is now made to FIG. 1 depicting logical attributes of an input data specification 100 provided by a first entity to one or more second entities or trading partners. Logically speaking, the first entity exposes three attributes of input data or input data document to partners (second entities)—1) structure 102 of input data, usually specified using industry standards such as EDI or XML format as represented by 108 and 110, 2) validation rules 104 associated with input data that may be further classified as business (semantic) rules 112 and syntactical or structural rules 114, and 3) Data elements 106 that may be further classified as partner dependant data elements 116 and specification provider dependent data elements 118. Examples of specification provider dependant data elements are some hardcoded constant values such as DUNS number identifier used in the input data document that are typically owned by first entity, but partners are required to provide these values in their input data. Examples of partner dependant data elements are the main portion of the input data such as invoice amount, invoice date and the like.

Prior-art approaches described below exposes entire details of input data spec 100 to partners and creates tightly coupled mapping between source and target data formats in systems such as middleware systems at both ends. For example, exposing specific structure such as XML 108 or EDI 110 binds all partners that use specification 100 to one particular format and this in turn has dependency to related structural rules 114 that is associated with standard implemented syntax rules. Additionally, it also adds to the partner dependant data elements that are specific to the standard that need to be supplied by partners, such as standard specific qualifiers and the like.

One well-known method of specifying B2B and EAI interchange requirements from one business entity (specifying business entity) to other (receiving business entity) is by using traditional textual description of structural and business rules associated with the data elements of the document and related process in the form of paper or electronic based manuals. Generally, these specifications are subset of associated document standards such as X12 or ChemXML with minor variations and business rules that are specific to the specifying business entity. Then, these descriptions are distributed using paper or computer readable media to partners to implement. These descriptions are then provided to technical team of receiving business entities to build “maps” from source to target data format and to develop business rule related coding. Since these specifications are textual or manuals, specifications are “disconnected” from actual implementation and realization of specification to implementation is highly manual and labor intensive.

Another slightly improved, prior-art technique is based on specifications that can be used to generate source code at both sender and receiver ends using appropriate tools. Then the framework created out of these specifications using the generated code is used to build maps and validation rules. One example of this method is well-known Web services, which can be automatically generated from Web service description language (WSDL) using tools such as Microsoft®.NET platform development tools, IBM® webservices toolkit for web services, and the like. Web services may accept one or more input data from partners and exposes some application logic processing using this data. Input data that are electronically transferred using these Web services are known as “payloads”. Definition of these payloads can be specified as schema definition such as XML schema, which is part of the WSDL itself. WSDL is not specifically designed for input data document specification, but for description of entire web service itself. Payloads exchanged using Web service may be as simple as single primitive data element or may be a complex business document such as an invoice or purchase order.

Another example of automated source code generated approach to B2B specification method is automated trading partner agreements or “TPA”s, developed by IBM® corporation. A trading partner agreement or TPA is a document that describes the general contract terms and other parameters under which two or more business partners communicate electronically for a particular set of business transactions. XML notations to represent TPAs are provided by XML notation known as tpaML (trading partner agreement markup language). Once complete and agreed-upon TPA has been created, the tpaML document is processed by a code generator at each business entity to generate software to control subsequent B2B transactions between these partners.

All of above prior-art methods expose great amount of specification details or attributes as described with reference to FIG. 1 to partners and even though source code generation helps to some extent, entire attributes of input data is made “public”. These attributes are custom programmed by each partner on their middleware or translator systems. This causes any minor modification to input data specification requiring change across entire integration landscape and involves all participating entities (partners). Some of well-known middleware software is Vitria.RTM., IBM Cross worlds.RTM. Gentran.RTM., Webmethods.RTM. and Microsoft BizTalk server. RTM.

Prior-art specification methods expose attributes of input data as described in FIG. 1 to partners to greater extent and depends upon partners for implementing these attributes. Since entire specification is made “public” in prior-art methods, they tend to create tightly coupled integration landscape that is tied to a specific standard and hardwired business rules. Any changes to these specifications—however minor it may be, and whether it impacts the business portion of the specification or not—require all involved partners to modify their maps and programs on middleware systems. This is time consuming, expensive and require high amount of coordination with partners. In some cases it is practically impossible. For example, companies using EDI for long time require lot of effort and cost to switch to XML based systems. This is because EDI standard or attribute 110 is “exposed” and “imposed” on partners by making this attribute of input data specification public to implementing partners.

Referring now to FIG. 1 again, validation rules 104 are typically implemented in middleware systems that “maps” source data to the input data (target data) of specifying entity. By not implementing these rules in middleware or similar systems causes receiving entity to receive invalid input data that increases cost and decreases efficiency of automated integration. On other hand, implementing them in middleware of each partner's system creates tightly coupled system that are not easy to change in case of changes to validation rules and increases dependency with partners.

Drawbacks of prior-art method are further described in greater detail in following sections. FIG. 2 depicts a block diagram of prior-art methods of specifying a input data document specification from a specifying business entity 200 or first business entity 200 or “Company-A” to one or more business partners 250 or second business entities 250 or trading partners 250. For example, consider that 200 provides specification of electronic invoice input data document to partners 250 such that 200 can receive electronic invoices from partners 250. According to one prior-art, input data or business document specification 202 may be a manual providing textual details of how to send the invoice electronically to first business entity 200 from partners 250. This manual may be based on EDI X12 810 standard or may be one of the XML standards such as chemXML, RosettaNet, cXML and the like. Assuming that 202 is based on EDI X12 810, specification 202 contains details which are described in terms of various segments, fields, loops and other syntactical structure built around X12 810 standards. Actual business data and rules are buried within this technical jargon.

Input data or business document specification 202 may be also specified using WSDL or tpaML using which partners can generate source code and corresponding document structures in their middleware systems. Next, at step 204, first business entity 200 develops maps in a middleware system to receive invoices from partners 250 and to convert into an internal data format such as SAP® IDOC. At step 206, 200 also develops validation rules in middleware system to validate correctness of incoming document before posting them to backend system, and at step 208, integration solution is deployed.

Partner 250 receives document specification 202 from first business entity 200 at step 252. 250 may receive specification 202 in the form of paper-based manual or as electronic manual downloaded from the web site of 200. The invoice document structure may be also specified as XML schema in associated WSDL or tpaML specification from which source code and corresponding target mapping structure in middleware systems may be automatically generated. If the specification is in textual format, at step 256, document structure and schema is built manually using utilities provided by middleware system. Technical team of partner 250 also tries to understand business rules specified in the specification 202 in preparation for implementation. If the specification is in formats such as WSDL or tpaML, source code and associated document structure will be automatically generated at step 254 using appropriate toolkits.

Both of these approaches results in implementation specification 258 that may be logically divided into standard specific information 260, business data fields 262 requested by 200 and business and validation rules or logic 264. Steps 266 to 272 focus on rest of the development and deployment of the B2B solution for sending the data document from 250 to 200.

Deficiency and drawbacks of prior-art techniques apply to these logical areas. Standard specific information 260 comprises details such as XML or EDI segments, hierarchies, qualifiers and other structural details. It also comprises several data values that are imposed by the standard agencies, but not exactly business related data items. Many of these types of data elements are hardcoded in prior-art maps. It's understood that standard specific or similar structure is required to transport the data document by preserving its contextual meaning over a computer network; however, exposing them to partners should be avoided. With prior-art, partners such as 250 map their source data format such as SAP IDOC directly to these standard specific structures. This causes tightly coupled integration solution that is tied to a particular standard and even to a particular version. For example, consider first business entity 200 changing from EDI to XML format. This would require 200 to communicate changes across all partners' landscape, distribute new specification and then depend upon partner's technical team to understand and implement these changes. Here dependencies upon partners are very high and every partner need to incur cost and time of modifications, some times making this type of change is very hard and expensive to achieve. Prior-art approaches, including WSDL type of approach, exposes entire schema of input data to partners in a certain format. For example, a WSDL specification may comprise input data specification in ChemXML format. If the first business entity 100 decide to change to a RosettaNet based XML format, it need to redistribute WSDL again. What should be noted here is, only format of data document is changing and not underlying business data itself. Implementation costs related to these types of changes should be avoided. This invention generally refers such standard specific constructs and details as transport specific specifications.

In order to illustrate structural specific attributes of an input data specification, reference is now made to FIG. 3. 340 depict an exemplary portion of EDI X12 810 invoice transaction. 350 depicts standard specific data portion (transport specific specification) that are specific to X12 810 standards, whereas 360 depicts “data fields to map” portion. Exposing language or standard specific constructs such as 350 to partners requires all the partners to build data structure of 350 or structural attribute 350 of input data specification in their middleware systems causing tightly coupled and standard dependant solutions and should be avoided. Even though language constructs such as 350 is required to preserve the meaning of data during transport of document across the network, exposing them to partners need to be avoided. Instead, such constructs needs to be part of “private” portion of the specification and binding of business data to these constructs need to be done internally.

Generally, each standard such as one based around XML and EDI require companies to hire experienced technical staff to understand and implement these specifications. This is expensive and especially small companies, who are part of the B2B community, cannot afford to maintain such technical department. Many times, changes have been done to specifications by one company and all other partners associated with that company are forced to make changes in their system, even if the changes are not business related. Such requirements have been driving up the overall cost of maintaining automated business-to-business integration.

Accordingly, what is required is, such transport specific specifications need not be exposed to partners at mapping level. Instead, such details should be given as private portion of a document specification and need to be controlled by first business entity such as 200. However, final data document message sent over the computer network should be in first entities preferred transport specific specification. So partner's responsibility should be shifted and reduced to—from mapping to specific standard to routing and transporting of data document message in specific standard.

Using prior-art methods, partners have hard time deciding what is actually mandatory, optional and conditional data elements in a data document specification. This is because document is based on some standard and many optional segments and data elements are exposed to partners that are not actually used. This adds unnecessary amount of information for partners to filter and to identify what is actually optional and conditional. Some times a data element in the standard may be mandatory, but both sending and receiving entity may not have valid business data to put in those fields and may put some hardcoded value to satisfy standard specification.

So, there is requirement in the art for a new method for document specification from one business entity to another, in which, only required data elements of the document is exposed and clearly documented.

Now let's address drawbacks with prior-art as applicable to logical area 262, which is specification of data fields to map. Typically after understanding the requirements 202 or after generating source code from 202, partners identify data fields that need to be mapped from their source data. Some examples of these data fields in case of an invoice document are invoice date, associated purchase order number, invoice amount and the like. Problem with prior-art approach in this area is, it exposes some private data that is controlled by the first entity to be provided by partners as mapped data field. For example, the first entity may be identified by a DUNS number and is used by an electronic marketplace such as an EDI exchange for properly routing the message. Clearly, such data is owned by the first entity. However, many prior-art techniques specify these values to partners and expect partners to map these values. This is unnecessary additional information that needs to be filled by partners. It is understood that partners need to aware of this value to build certain routing rules to correctly transport associated data document message, but mapping this at different locations in the map need to be avoided. For example, consider the first entity changing its DUNS number due to a sale or acquisition; all partners need to make changes in their code or map. Similarly, there may be some hardcoded values that rarely change, but still required by partners to map.

Accordingly, there is requirement in the art to limit exposing unnecessary data fields that need to be mapped from partners, but still need to incorporate them in the final data document message that is sent over computer network. Specifying entities such as the first business entity should be able to change these values without depending upon partners to change each of their maps in partners' data processing systems.

Now let's address drawbacks with prior-art as applicable to logical area 264, which is implementation of business and validation rules check by partners. This is one of the time consuming development effort need to be done at partners end to avoid sending erroneous data documents to trading partners such as the first business entity 200. These business and validation rules are coded in systems such as middleware systems. However, business rules tend to change and any such changes would require changes by all trading partners. On the other hand, not implementing validation rules in the middleware on partners 250's end causes increased error and manual involvement, which is not desirable. So, it is desirable, if business and validation rules 254 should be controlled directly by the first business entity 200, yet executable on partners 250's end and should be treated as private, executable portion of the specification that is only readable by partners. With current approach it's possible to validate the data document against a schema specification such as a XML schema, however, many conditional validation rules cannot be verified using XML schema. Referring now to FIG. 1, XML schema type approach works well for validating structural rules 114, but not for validating business rules 112. For example, an invoice document may be used to send a regular invoice as well as a credit memo, and is decided at run time based on the total amount of the invoice (negative or positive). Regular invoice and credit memo may have totally different business rules. Validating this type of scenarios using static XML schema is not possible. Accordingly, there is need in the art to provide validation rules to partners as private, yet executable specification.

With prior-art methods, rules associated with validation of input data are implemented separately at both sending and receiving partner ends as independent tasks. For same message, there is duplication of efforts on both ends, increasing the overall cost and time for implementation of such messages. Moreover, any changes require modification to related codes on both ends. This should be avoided. Instead, it is preferable to develop one version of rule instructions, which may be used on both ends, thus reducing the duplication of efforts and increase consistency of rules on both ends.

More recently, the concept of semantic integration has been introduced in the art for providing inter-operability between disparate applications and data sources. However, this paradigm focuses more on inter-operability in terms of ease of mapping between different disparate data sources such as source and target data of business-to-business integration. Prior-art methods using this approach typically provide some type of “wizard” computer applications to build neutral representation of external and internal data formats and maintain database tables to establish relationship between external data format to neutral representation and from internal data format to the neutral representation. This neutral representation may be in form of semantic business vocabulary. Some intermediate party need to be aware of both external and internal data format and actually someone will be building “map” between external format to the neutral format and from internal format to neutral format and are stored in the database tables. In theory, by using this information in the repository, an application can automatically convert external data format to the internal data format and vice versa. These types of tools may provide external and internal adapters to help interact with the neutral representation. Someone needs to import external data format objects as well as internal data formats into these “wizard” applications to establish the relationship. In practice, they “shift” mapping task from one tool (such as middleware system) to another (such as “wizard” application). However, since the relationship is stored in the database, reusability of identical mapping operations may be achieved by using such tools.

Even though there are certain benefits to the semantic integration approach such as reusability of maps, they tend to focus on “after fact” rather than to the heart of the problem itself. They focus on solution to existing problem rather than to correct the problem itself. In many situations, data document specification tends to create point-to-point solution from one partner to another and the method of data specification itself needs improvement rather than to build semantic models around existing external and internal data format. In addition to this, Semantic integration does not provide solutions to some deficient areas in the integration arena such as imposing client side validation and processing and lack of this facility is one of the leading causes of exchanging erroneous transactions between trading partners. So, what is required is—data format of an entity should not be exposed entirely; Instead, there is requirement in the art to expose specification of input data document itself as an object executable at partners, wherein the object comprises minimal outside data exposure as public interface definition and private section with encapsulated instructions for validation and conversion to first entity's preferred format.

Overall, exposure of input data attributes explained with reference to FIG. 1 to partners or second entities need to be reduced from prior-art levels. There is a requirement in the art to provide input data specification 100 as private and public sections combined into a specification object, wherein only minimal attributes were exposed as public portion and rest of attributes as private section and entire specification object is released to partners as specification, which can be interfaced and executed at partners' end.

### SUMMARY OF THE INVENTION

The present invention is directed to a method and system for creating input data by a second entity in compliance with specifications of a first entity by using a specification object provided by the first entity, wherein the input data is transferred from second entity to the first entity over a computer network. The specification object comprises exposed input data definition and private executable instructions and distributed to second entity as one or more computer files. A specification interface system is provided to the second entity that receives a processing request comprising identifier of the specification object and exposed input data instance from a first data processing system of second entity and creates generated input data by executing the specification object. The generated input data is sent to the first entity over the computer network.

In accordance with one aspect of the current invention, a specification object is created and distributed to trading partners by a first entity or on behalf of first entity, corresponding to electronic business documents such as invoices and purchase orders, for a business-to-business integration scenario, in which trading partners send these business documents electronically to the first entity over a computer network. A specification interface system (SIS) is used by trading partners to execute and manage the specification object, wherein the specification interface system acts as “container” for the specification object. The specification object provided by the first entity is uniquely identifiable and comprises public interface definition and private section. The public interface definition further comprises exposed input data definition and generated input data definition. The private section hides many attributes of input data such as final structural representation and validation rules and comprises computer executable instructions to generate final structural representation of input data and validation instructions. SIS generates record structure from exposed input data definition in preferred structure of trading partner's middleware system. SIS also comprises a specification interface client that transparently interfaces the middleware system with SIS and hence with the specification object. The middleware system maps source data to the record structure to create exposed input data instance and issues a processing request to the SIS causing execution of instructions in private section of the specification object. If processing of the specification object is successful, SIS creates generated input data, which is sent as at least a portion of the business document message to the first entity. Since many attributes of input data is encapsulated in the private section of specification object, any modification to the private section is easily accomplished by first entity by creating a new private section and releasing a new version of specification object.

In accordance with another aspect of the invention, specification object is used in conjunction with web service that accepts at least one input data from consumers of the web service. A first entity exposes the web service to one or more second entities (consumers) over a computer network such as the Internet. The first entity provides web service definition language (WSDL) to second entities corresponding to the web service. However, instead of providing input data schema in the WSDL, the first entity provides reference to the specification object corresponding to the input data. The specification object is also distributed to second entities and loaded into the SIS. Input data is logically divided into exposed input data that is exposed to second entity and, final input data that is actually generated from the specification object and sent to the web service in a SOAP (simple object access protocol) request over the computer network. The specification object takes care of first entity imposed validation and conversion of exposed input data that is actually executed at second entity by using the SIS.

Further details of aspects, objects, and advantages of the invention can be realized by studying the detailed description, drawings, and claims as described below.

### BRIEF DESCRIPTION OF DRAWINGS

The accompanying drawings are included to provide a further understanding of the invention and, together with the Detailed Description, serve to explain the principles of the invention.

FIG. 1 depicts logical attributes of an input data specification that is provided by a first entity to one or more second entities or partners.

FIG. 2 illustrates prior-art process of providing a data document specification from one entity to another in a business-to-business integration scenario.

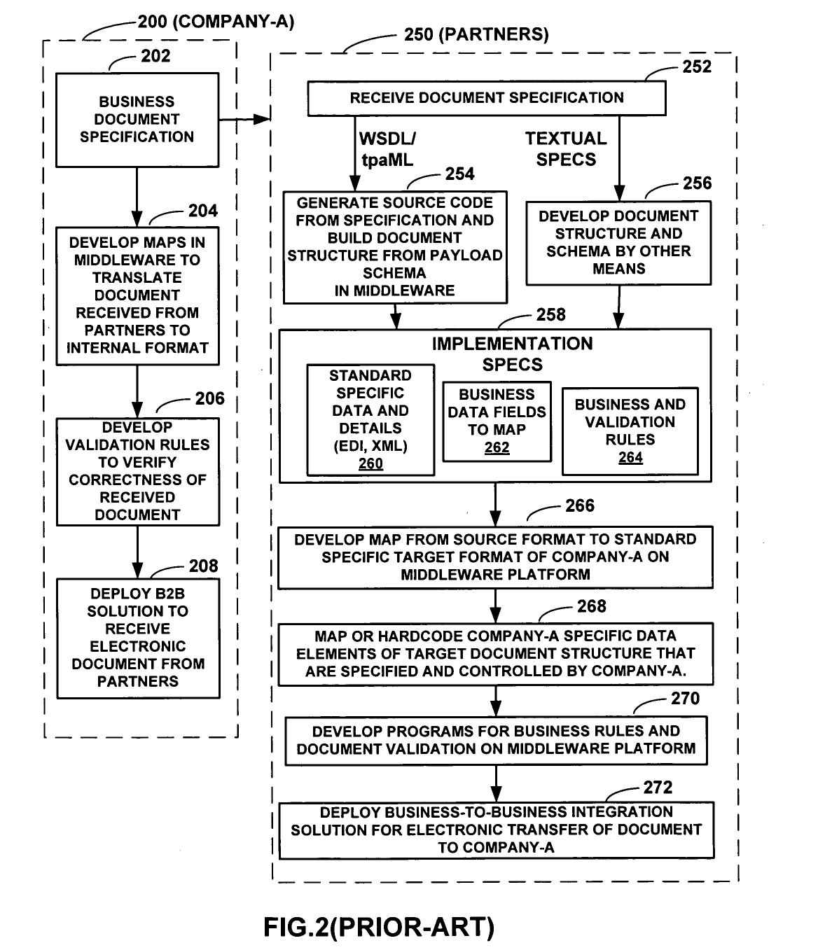

FIG. 3 is a block diagram illustrating structural attributes of an exemplary EDI document.

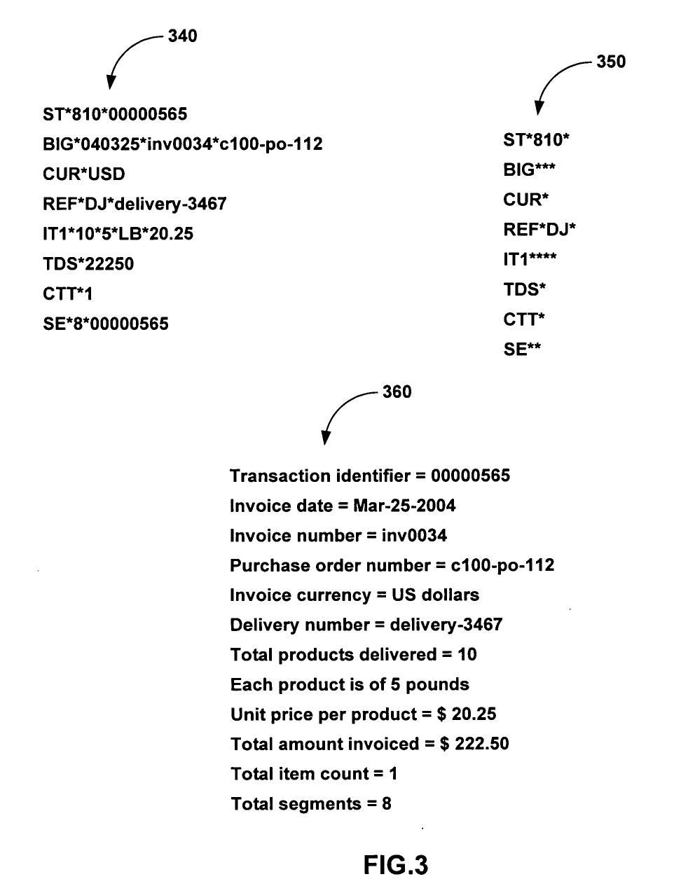

FIG. 4 illustrates using a specification object to create and transfer a input data document from a second entity to a first entity over a computer network, in order to quickly understand the concepts of present invention.

FIG. 5 depicts a block diagram showing structure of a specification object.

FIG. 6 depicts a block diagram illustrating a specification interface system that is used to execute and manage specification objects.

FIG. 7 is an exemplary programmatic call made by a first data processing system of a second entity to invoke a specification object in the specification interface system.

FIG. 8 is a flow chart showing a method of using specification object to create input data document in accordance with specification of a first entity.

FIG. 9 is a block diagram depicting process of prior-art web services to create and send an input data to a web service from a second entity to first entity over a computer network.

FIG. 10 is a block diagram depicting process of creating and sending an input data to a web service from a second entity to first entity over a computer network using a specification object.

FIG. 11 is a flow chart showing a method of using specification object in conjunction with web service to create and transfer input data in accordance with input data specification of a first entity.

### DETAILED DESCRIPTION

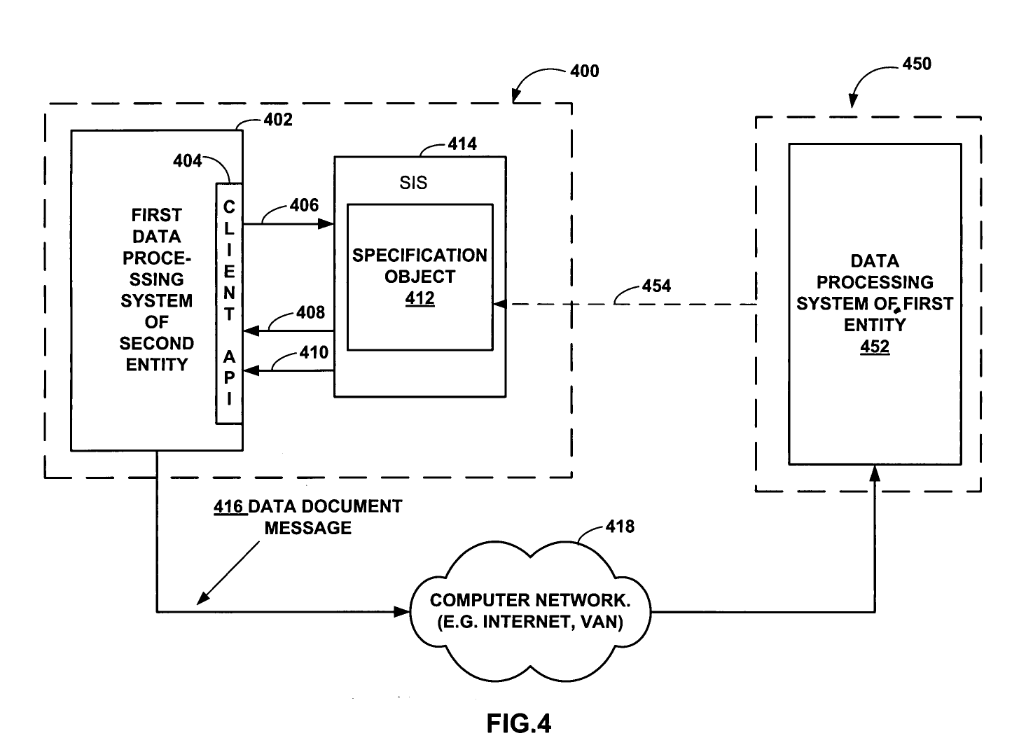

In order to quickly understand the overview of the current invention, reference is now made to FIG. 4, which depicts a block diagram of using specification object 412 to electronically transfer a data document (business document) message 416 or input data 416 from company 400 or second entity 400 to company 450 or first entity 450 over a computer network 418.

Specification object 412 corresponding to data document message 416 is created and maintained by the first entity 450 and is supplied to the second entity 400 in a computer readable media or downloaded by second entity from a remote network site hosted by or on behalf of first entity. Specification object 412 comprises an interface definition that is public to external business entities such as the second entity, and a private section comprising executable instructions and private data. The interface definition further comprises an exposed input data definition and generated input data definition. In physical form, the specification object may comprise a first file in XML schema format corresponding to the interface definition and one or more second files corresponding to the private section. The specification object is represented or identified by a unique identifier. Dotted line 454 from first entity to the specification object 412 indicates that it is provided by the first entity (or on behalf of first entity) and contents of the specification object 412 are controlled by the first entity (or on behalf of first entity).

The exposed input data corresponds to one or more data fields that need to be mapped by second entity 400. The exposed input data comprises only relevant data fields that need to be supplied by second entity 400, for example, in case of an invoice document message, this may correspond to data fields such as invoice date, invoice amount and the like. The private section comprises first instructions or computer code to validate the exposed input data instance and second instructions to create the generated input data instance from the exposed input data instance. The private section may further comprise many internal or private data variables that may be used by first and second instructions. Specification object itself is described in greater detail in later sections.

The specification object 412 is typically provided as one or more computer files. In order to utilize the specification object 412 or to make it functional, it needs to be loaded into and processed by a specification interface system 414. The specification object 412 in conjunction with specification interface system 414, exposes the specification object to external data processing system such as first data processing system 402 of second entity.

The exposed input data definition can be used to generate corresponding record structure definition in a format of first data processing system 402. Once such record definition is built into the first data processing system 402, mapping is performed in 402 from a source data to the record structure resulting in exposed input data instance. A specification interface client 404 is used to interface 402 with SIS 414. Client 404 exposes the services of SIS as native programming interface of first data processing system 402. Using client 404, 402 issues a function call comprising the exposed input data instance and the unique identifier of specification object.

The specification interface client 404 converts this function call into a processing request 406 comprising the unique identifier and the exposed input data instance. The SIS 414 further comprises third instructions or computer code to handle incoming processing request 406. The SIS 414 parses the processing request message and processes or executes corresponding specification object, which in turn causes the execution of first and second instructions in the specification object. If the validation done by the first instructions is successful, second instructions create the generated input data instance 408, which corresponds to at least a portion of the data document message 416. The SIS also returns overall processing status 410 or processing message 410 back to the first data processing system 402.

It should be noted that the specification object 412 is created and provided by first entity 450 and contents of the specification object 412 are strictly managed by the first entity, and the second entity only utilizes the services of the specification object 412 via, a specification interface system or SIS 414. In other words, the specification object 412 is a “black box” and the second entity need not understand the technical details of implementation of the specification object 412.

The processing request 406 may be in an intermediate XML format and specification interface client 404 creates this request internally from the exposed input data instance and the unique identifier received from the first processing system. The specification interface client 404 is specific to the first data processing system. For example, the SIS 414 may provide one specification interface client on Webmethods® middleware platform and another specification interface client on SAP Exchange Infrastructure® middleware platform.

We can notice that specification object 412 hides many implementation details from partner 400. If there are any changes to the private section of specification object 412, partner 400 need not make any mapping changes in the middleware platform 402. Partner 400 only needs to download a new release or version of specification object from first entity 450 and the SIS 414 takes care of changes automatically. Exposed input data specification of specification object 412 exposes only essential data of the data document that is required from the second entity 400, while hiding details or input data attributes such as language or standard specific constructs, business and structural validation rules and other data that is controlled by the first entity 450 as private section of the specification object 412.

It should be noted that final format of the data document message 416 is generated by second instructions in private section of the specification object 412. For example, the second instructions may receive exposed input data instance corresponding to an invoice and generate an X12 810 EDI message, a ChemXML invoice document message or a SOAP request message. Since private section is created and provided by the first entity, even major changes like change of format of the data document message 416 can be easily achieved with hundreds of partners by simply releasing another version of the specification object 412 with modified second instructions.

Now, benefits of present invention compared to prior-art techniques may become clearer. Prior-art methods expose entire data document content and rules to partners such as the second entity 400. For example, automated specification techniques such as WSDL (web service definition language) and trading partner agreements provide entire specification to partners and any small changes to these specification need regeneration of source code and associated interfaces. By using the teachings of the present invention it should be noted that specification contents are split into public interface definition and private section, so, any changes to private section may be easily accomplished by the first entity with no or minimal dependency with partners. You can notice that such changes are not easily accomplished with prior-art methods. Moreover, since validation is written as instructions, many complex validation rules can be easily achieved, and sending erroneous document message to the first entity can be avoided to a greater extent.

This invention is described in terms of business document such as invoice, purchase order and the like. However, this invention can be applied to any types of data document that are electronically transferred from one entity to another. The entities can be any entity, including individual users. Furthermore, the SIS may be invoked from any system and not necessarily need to be a middleware system. So, it should be noted that such terms are used only for better understanding of the invention and should not be construed as limitation.

When this invention uses the term first and second entity, it equally applies to any third party such as a computer service provider acting on behalf of the these entities to create and/or supply the services of specification object. Description and claim of this invention should be interpreted accordingly and should not be construed as a limitation.

Specification Object

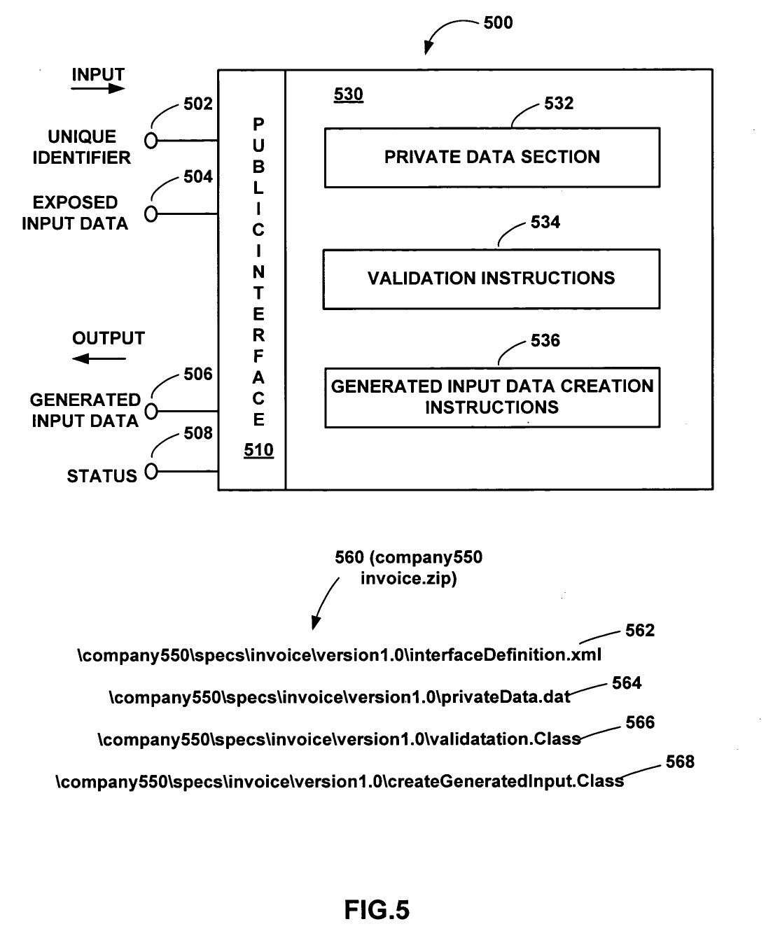

Referring now to FIG. 5, 500 depict logical view of an exemplary specification object provided by Company-550 (first entity) to its trading partners (second entities). 560 represent corresponding physical representation of this specification object with a plurality of computer files. At logical level, the specification object 500 accepts input processing request comprising unique identifier 502 and exposed input data instance 504 as input and creates generated input data or generated input data instance 506 and status 508 as output. This generated input data is sent as final input data (data document message) to the first entity or used to create a portion of final input data that is sent to the first entity over a computer network.

According to the logical view, the specification object 500 comprises public interface 510 and private section 530. This public interface is represented by interface definition file 562 in physical representation or physical view 560. In this example, this is specified using XML schema. The public interface 510 is exposed by the specification interface system according to the interface definition of the specification object. The interface definition comprises of exposed input definition and generated input definition. In logical view 500, exposed input data instance 504 and unique identifier 502 combined, corresponds to a processing request. The unique identifier enables the specification interface system to activate corresponding specification object. In this example, the unique identifier is “company550invoice”.

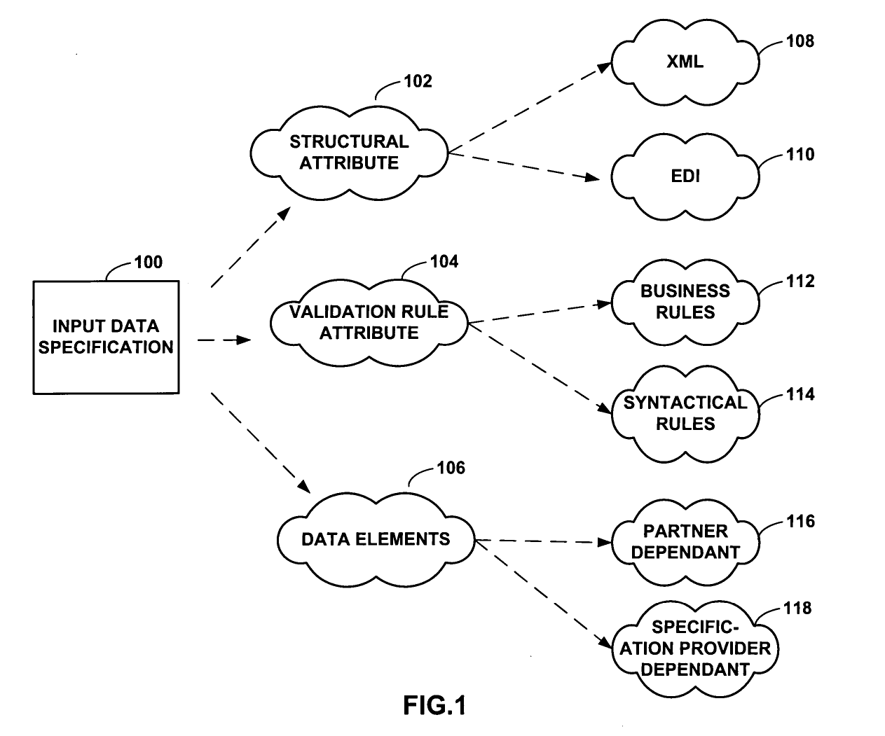

Private data section 532 comprises many internal data items used by the instructions of the specification object 500 and is internal to the specification object. This section comprises transport specific or standard specific data items such as name of qualifiers, segments and hierarchical constructs. This section also comprises private data that is controlled by first entity (attribute 118 of FIG. 1), such as DUNS number of first entity and the like. It may also comprise some default or hardcoded values set by the first entity. Generally, it comprises all data values that may be required by the instructions of the specification object, but are not required to be exposed to partners. In its physical form, private data is supplied in a data file 564. In its simple form, the file 564 may comprise one or more name-value pairs; for example, “DUNS=05868CSP”.

Private data section 532 further comprises help text sub section. Help text provides detailed help related to implementation of the integration solution for the data document. Help text comprises details of interface definition, how to map exposed input data, associated rules, examples and the like. Help text may be viewed by a user by using a user interface component of the specification interface system.

Validation instructions 534 (also referred as first instructions) comprise computer instructions to validate exposed input data and generated input data against business and syntactic rules associated with the document. Corresponding exemplary physical representation is 566, which is a Java class that is directly executable using a Java virtual machine. If there are any validation failures, it will be reported back to the first data processing system using status output 508. Since validation is done using computer instructions written in a high level programming language such as Java, powerful validation of incoming document is possible, without imposing them on partners. If there are no changes to the interface definition, many internal business rule modifications can be easily achieved with minimal dependency with partners. Moreover, the first entity may maintain one version of validation instructions that may be used by both first entity as well as partners. For example, both sending and receiving partners may use identical validation instructions used in the specification object to validate data document.

Generated input data creation instructions 536 (also referred as second instructions) are computer instructions to generate at least a portion of the data document message in first entity transport specific specification. Corresponding exemplary physical representation is 568, which is a Java class that is directly executable using a Java virtual machine. These instructions are responsible for converting exposed input data instance received from partners into first entity preferred format and hierarchical representation. Since these instructions are provided as private section of the specification object 500, specifying entities such as the first entity can easily modify them when the requirements change. For example, one version of the specification object may have instructions to convert exposed input data to EDI X12 810 format. Some time later, the first entity may want to change to a XML based electronic marketplace to reduce expenses. The first entity may release another version of the specification object with instructions to convert exposed input data to XML based standard.

A specification object may be associated with one or more versions, wherein each version is associated with some changes associated with the specification object. However, just one version is active at a time and unique identifier of specification object always point to this active version.

The instructions used within private section of the specification object may be in a computer interpretable language such as SmallTalk, Basic, or may be in byte code format such as Java class. These instructions may be also in pure binary format that are readily executable by a computer processor. Java class is only used for exemplary purposes and not to be construed as limitation.

Specification Interface System

The specification interface system (SIS) is responsible for hosting one or more specification object(s), providing means to execute, manage, create and view the specification objects. Specification interface system acts as container for a specification object. According to this invention, each partner or second entity utilizes the SIS with appropriate specification object before sending a data document message over a computer network to a specifying partner or first entity.

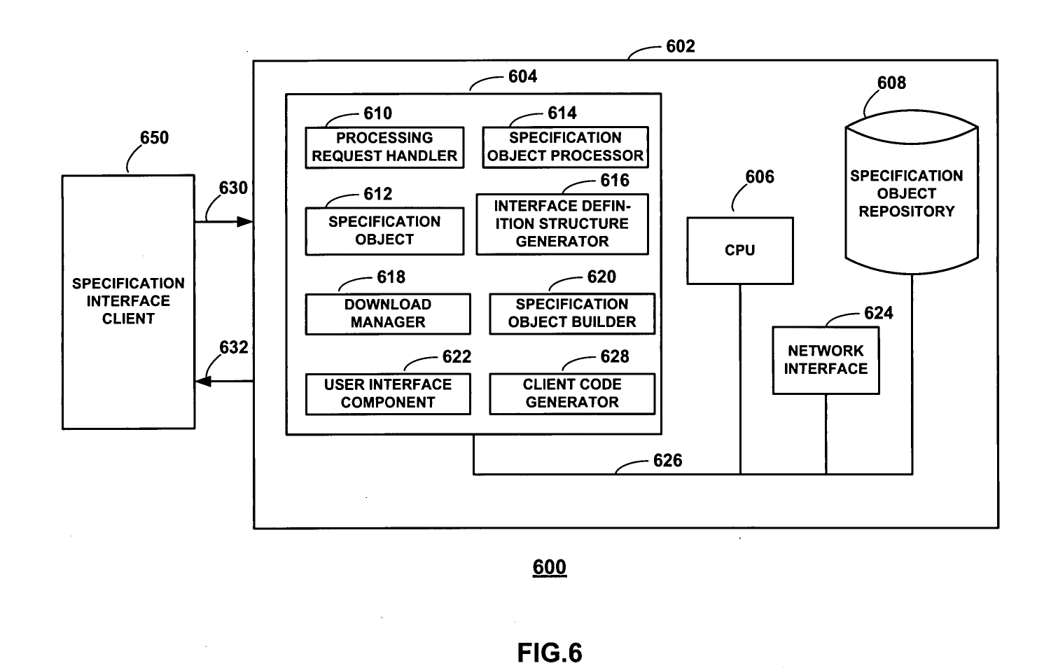

FIG. 6 depicts a block diagram of specification interface system 600 in accordance with preferred embodiment of present invention. System 600 is implemented on computer system 602 having a memory, bus, processor, network interface, input and output devices such as keyboard and computer monitor. Details of computer are well known in the art and are not explained in greater detail or shown in the figure. Each block or module of FIG. 6 is shown based on functionality performed by the specification interface system. These blocks or modules are implemented as executable instructions and reside on one or more memory 604 of the system 600 and executed by the processor 606 to achieve intended results in according with the teachings of present invention. All components of the computer such as processor 606, network interface 624 are connected each other by a system bus 626.

608 represents specification object repository, which is persistence storage for various specification objects from multiple business entities for multiple business or data documents. SIS has one or more means such as download manager component 618 for receiving specification objects from partners (first entities) and to load into storage 608. Storage 608 typically resides on hard disk of computer system 602 and can be loaded into memory 604 for processing. Various implementation of storage 608 is possible, for example, it may be stored in a relational database or may be scattered as multiple files on a file system directories in local or remote computer. Storage 608 also may hold various temporary or intermediate data required by modules in memory 604. It should be noted that more than one version can exist for a specification object represented by unique identifier. However, only one version is active and the unique identifier corresponds to this active version. Each version corresponds to some change made to the specification of the data document.

Module 610 is a processing request handler responsible for accepting exposed input data instance and unique specification object identifier from external data processing system (first data processing system) such as a middleware or translator system. In one exemplary scenario, this processing request may be in an intermediate XML format with exposed input data and the identifier. The external interface system may communicate with SIS 600 via an HTTP interface. Processing request handler comprises computer instructions to parse these request and loads appropriate specification object 612 into memory 604 from repository 608. Generally all the instructions related to the specification interface system are referred as third instructions for illustration.

Module 614 comprises instructions to trigger execution of validation and generated input data creation instructions of the specification object 612 on processor 606. If instructions of specification object are in an interpretable language such as Basic or JavaScript, it may invoke corresponding interpreter. If it's in Java byte code, it may invoke a Java virtual machine to process these instructions. After successful execution of the specification object, generated input data instance 632 will be sent back to external data processing system in response to input processing request 630.

Interface definition structure generator component 616 is used to generate record definition corresponding to the interface definition in external (first) data processing system format. This provides a record structure in data processing systems such as middleware that may be used as target record structure during data mapping. For example, component 616 may generate Webmethods.RTM. based record definition corresponding to exposed input data definition that can be directly readable by Webmethods middleware to automatically create a record structure that may be used as target record structure for mapping purposes by trading partners. The component 616 may support various middleware and backend platforms.

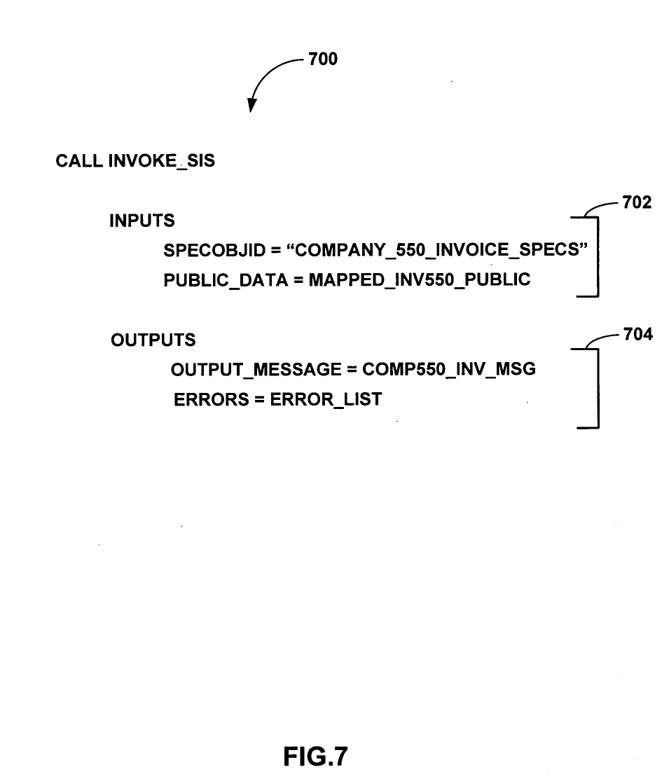

Specification interface client 650 acts as an interface between external data processing system (first data processing system) and the specification interface system. For example, the processing request 630 may be in custom XML format and interfaced with SIS using HTTP protocol. The specification interface client 650 can hide these details and exposes an easy to use API (application programming interface) in external data processing system native language. Referring now to FIG. 7, an exemplary function call 700 corresponding to this specification interface client, 702 correspond to processing request sent to the SIS. “company_550_invoice_specs” corresponds to a specification object identifier and “mapped_inv550_public” corresponds to exposed input data (or exposed input data instance). In this example, “mapped_inv550_public” is in a format of external data processing system and specification interface client 650 is responsible for converting them to appropriate internal format such as custom XML format used by SIS. 704 correspond to output received from the SIS, wherein “comp550_inv_msg” corresponds to a generated input data instance and “error_list” corresponds to processing errors or messages. It should be noted that client 650 provides a transparent interface to the SIS in first data processing system native language format.

It should be noted that generated input data of 704 may corresponds to entire data document message sent to the first entity or may corresponds to a portion of the data document. As an example, the generated input data may be an entire EDI X12 810 invoice message including the X12 envelope or may comprise only 810 section beginning with ST segment. The first data processing system further may group them together, and may take care of enveloping them. If there is any validation or processing errors in SIS, it will be reported in error message of 704, then the first data processing system will notify appropriate department and may not send the data document message to first entity.

Module 618 is a download manager for automatically receiving specification objects from trading partners. Receiving specification object may be by means of pulling it electronically from trading partner's URL (uniform resource locator), or may be pushed by trading partner. Module 618 may further contain scheduled jobs that check for any new updates to the specification object and download them automatically, if change exists. Once a new version is downloaded, 618 may alert a user about download.

User interface component 612 acts as dashboard and administrative screen for all the activities associated with SIS 600. Using 610 and 612, user can view canonical representation of public data elements, any help associated with documents, example data documents and any portion of the specification object; however, the user is not allowed to make any changes to specification objects that are created by external partners.

Specification object builder 620 is responsible for creation of new specification objects. 620 uses business and technical vocabulary data to build various data elements of the specification object. Specification object builder 620 also brings up preferred editor to insert various instructions of the specification object as described in earlier sections. Various user interaction activities between a user and the SIS 600 are controlled by user interface component 622. For example, user may view help section of the specification object using component 622. Client code generator 628 is responsible for generating skeleton code or templates to invoke SIS via specification interface client and there may be more than one client code generator 628 for different platforms.

It will be clear that the embodiment as shown in FIG. 6 is simplified for ease of understanding, and that any combinations of computer systems in networks may equally be used in implementing the various components of SIS 600, having the features of the preferred embodiments of the present invention. Moreover, various modules may be implemented using different computer languages. Again, above illustration should not be construed as limitation, rather should be used for understanding of the invention only. Further, a computer program or instructions referred in current invention may consist of components, modules, objects, routines or sequence of instructions, blocks of code sections, each performing a specific unit of work at different time intervals during the execution of the computer program. Also, computer program may be written in various languages to produce more or less similar results. Furthermore, computer program may be part of an operating system, or other application programs. Also, computer programs are composed of variables and data structures that either reside locally to a program or are found in memory or storage devices. Any specific nomenclature used in this description is for illustrative purposes only and not to be construed as a limitation.

Method of Using Specification Objects.

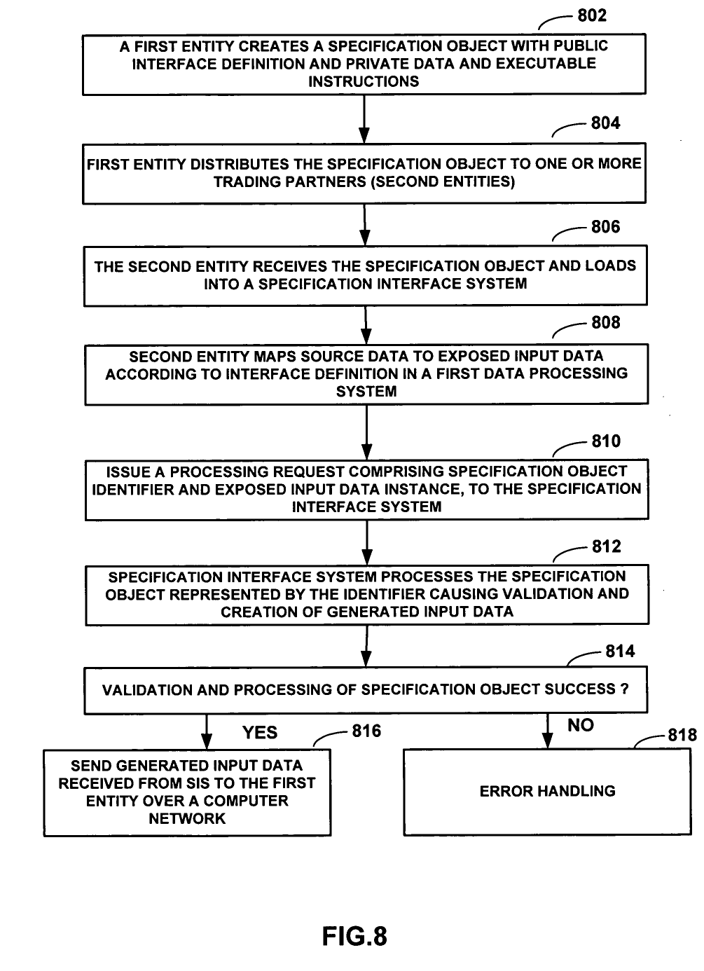

FIG. 8 depicts a flow chart of an exemplary method of using a specification object for generating an input data document message by a second entity, complying with the specifications of a first entity. At step 802, the first entity creates a specification object having contents in accordance with the teaching of current invention as disclosed in earlier sections. At step 804, the first entity distributes the specification object to one or more of second entities (trading partners). This may be done by distributing the specification object in a computer readable media such as CD-ROM, publishing on a web site and the like. At step 806, the second entity receives this specification object and loads into the specification interface system, which is described in earlier sections. Loading the specification object into the SIS makes the services of specification object available to external data processing system by application-programming interface exposed by the SIS.

At step 808, the second entity maps from source data format to the exposed input data format in accordance to the interface definition, in a first (external) data processing system such as a middleware system. During this step, the second entity may generate a record structure of the exposed input data in a format usable by the first data processing system by using the services of SIS. For example, the second entity may map from a source data in SAP IDOC format to record structure generated from exposed input data definition.

At step 810, the second entity utilizes the specification interface client services to make programmatic issue of a processing request to the SIS, wherein the processing request comprises the unique identifier of the specification object and the exposed input data or exposed input data instance. This request is issued by executing instructions (also referred as fourth instructions) in the middleware system. The middleware system may make this processing request in its native language or notation by using the services of the specification interface client. For example, if the middleware system is based on Java, the specification interface client may expose a Java API (application programming interface) to the middleware, using which, it may communicate with the specification interface system.

At step 812, the specification interface system processes the processing request from the first data processing system, which triggers the execution of the specification object, which in turn results in creation of the generated input data as explained in earlier sections. Processing status, corresponding to this execution will be reported back to the first data processing system along with the generated input data.

At step 814, the first data processing system receives the status and generated input data or generated input data instance from the SIS and checks whether the status is success. If the status is success, the generated input message will be sent to the first entity at step 816 or is used to prepare the final data document message that will be sent to the first entity. If the status is failure, it won't be sent to the second entity, rather is dispatched to error handling section 818.

Enhanced Web Services Using Specification Objects.

In accordance with another embodiment of present invention, specification objects are used in conjunction with existing web services to perform client side processing before performing actual invoke of the web service to avoid or reduce, making web service call with invalid data and/or to perform client side conversion to input data before making the web service call, without requiring developing code by users of the web service.

This embodiment is explained using what is now commonly known as web services. However, it should not be construed as limitation, and current invention can be equally applicable to similar technologies. Generally, a web service is an application or business logic that is accessible using standard Internet protocols and designed for computer-to-computer communication. Web services are exposed from first entity to one or more second entities such that computer programs executing on second entity can access this business or application logic by invoking the web service causing execution of computer program associated with the web service on a system of first entity.

Since web services are based on standard Internet protocols, systems of first entity and second entities may be executing on completely different platforms. Further, a web service can be identified by URI (uniform resource identifier) and it's public interface and bindings are described using XML, commonly known as Web service description language (WSDL). Even though, implementation of the web service logic is hidden from second entities, input data parameter and rules associated with input data parameter is still exposed in greater detail. For example, if first entity provides a web service to receive invoice from second entities, first entity need to expose entire structure of the invoice data document and the business logic associated with validation of invoice to second entities. Complex business logic cannot be verified using code generated from associated XML schema of WSDL. Further, regeneration of associated source code due to business rule changes are not desirable and causes changes at second entity. This leads to drawbacks that are detailed in prior-art section of this invention.

Web services are specified using Web service description language (WSDL). WSDL can be loaded by tool kits such as Microsoft® Visual Studio.NET or IBM® Web service tool kit to generate source code for the framework required for invoking the web service in preferred language. WSDL provide structured way of representing web services by using a XML grammar for describing network services as collection of communication endpoints capable of exchanging messages. Input and output data parameter of a web service is described in “message” section of WSDL and it makes use of XML schema notation to represent the data structure of input and output messages.

Current embodiment is applicable to application logic such as a web service exposed by the first entity, which accepts at least one input data parameter from the second entity, and the input data parameter is passed to the application logic to perform some useful services for the second entity. In order to better understand this embodiment, few examples are provided below that may utilize this embodiment of current invention.

With prior-art web services, a first entity exposes an application logic accepting an input data from a second entity. However, the first entity does not have control over what is actually sent from the second entity to the application logic. In accordance with this embodiment of the present invention, the input data to application logic such as a web service is split into exposed input data and final input data. The final input data is actually what is received from second entities over the computer network by the application logic. The exposed input data is what is actually exposed to the second entity. The first entity provides a specification object corresponding to the input data to second entity. The second entity maps exposed input data and issues a processing request to a specification interface system comprising the specification object identifier and the exposed input data instance, as explained in earlier sections. This causes execution of the specification object and creation of generated input data instance. This generated input data instance is sent to the first entity as final input data over the computer network as a SOAP request.

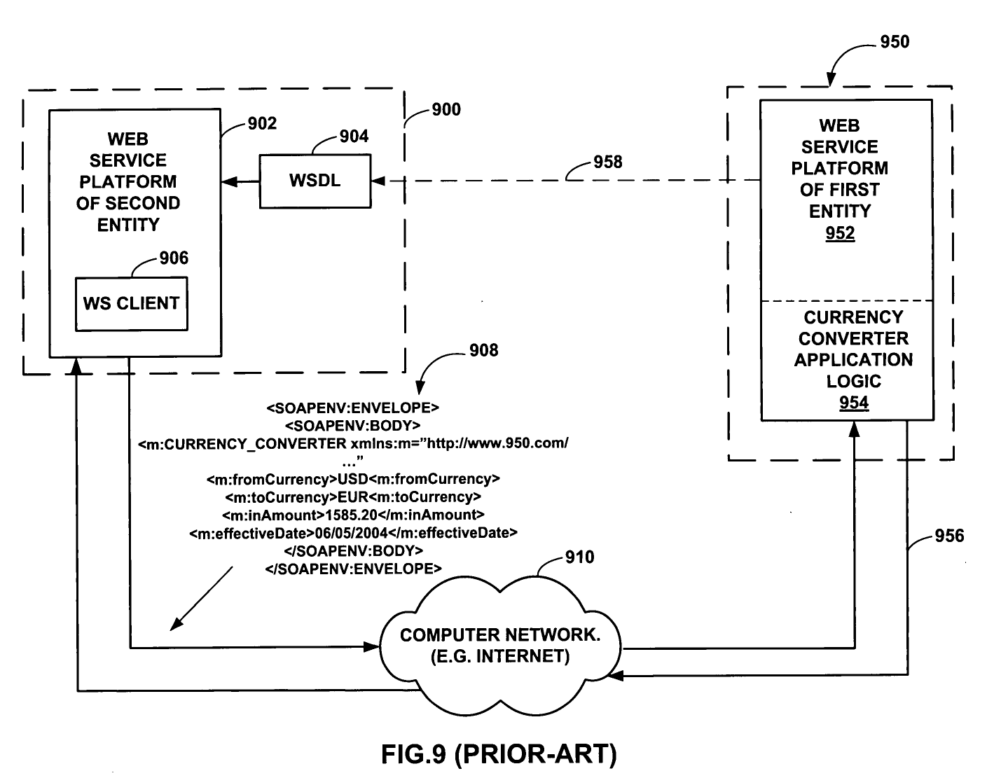

In order to better understand this embodiment of the present invention, an exemplary currency conversion web service, exposed by a first entity to one or more of second entity is used. Referring now to FIG. 9, which depicts prior-art of using this web service, a first entity 950 exposes currency converter application logic 954 using a web service platform 952 such as Microsoft®.NET platform. The currency converter application logic accepts four input data parameter from second entity, which is sent as SOAP request 908 from second entity 900 to first entity 950 over a computer network 910 such as the Internet. Inputs, namely, from currency code, to currency code, input amount and effective date is passed to the application logic in accordance with XML schema provided by 950 in message section of WSDL 904. Specification and usage of WSDL is well known in the art. In response to these inputs, the application logic 954 performs currency conversion and returns a SOAP response 956 back to the second entity. The web service platform 902 of second entity may use WSDL 904 to generate portion of the code to build web service client application 906 to invoke the application logic. Dotted line 958 indicates the WSDL 904 is supplied by the first entity 950 or on behalf of 950.

Now, consider the scenario, in which the currency conversion logic may not work for some combination of from and to currency codes. This may be a limitation, which the first entity would like to improve in future. Specifying valid combination of source and target currency codes using XML schema in WSDL 904 may not be achievable. However, first entity would like to eliminate these type invalid calls hitting their platform 952. This makes the first entity 950 to depend upon partners such as 900 to custom build such validation logic in web service client application 906. This type of situation can be easily handled by this embodiment of current invention as shown in later sections.

In another case, the first entity may want a universal date value in effective date input parameter rather than in local date value, in order to correctly identify the currency exchange rate associated with the request. For example, one of second entity may invoke this service from India, whereas another second entity may invoke this service from USA. In these scenarios, exchange rate will differ for same effective input date. One way of handling this issue is by imposing second entities to convert input date and time to universal time such as GMT (Greenwich Mean Time) in client application 906. However, this puts burden on users of web service, which may not be preferred; Instead, first entity may release a specification object according to teachings of this invention, comprising private section with instructions to convert input effective date to GMT date before invoking the web service.

In yet another requirement, the first entity may want all 4 input parameter as one input parameter separated by commas in order to reduce the size of SOAP request 908. For example, instead of sending input as “<fromCurrency>USD</fromCurrency><toCurrency>EUR</toCurrency><in Amount>1585.20</in Amount><effectiveDate>Jun. 25, 2004</effectiveDate>”, the first entity may prefer one input parameter such as “<input_values>USD, EUR, 1585.20, Jun. 5, 2004</input_values>”. With prior-art web services, there is no easy way to achieve this other than requiring users of web service to code this logic at client end 906, and such changes would have required change of application logic interface definition or WSDL 904. Such requirements can be achieved by using the teachings of this embodiment of current invention. In short, using this embodiment of present invention, the first entity such as 950 can achieve greater control over the input it should receive from second entities such as 900.

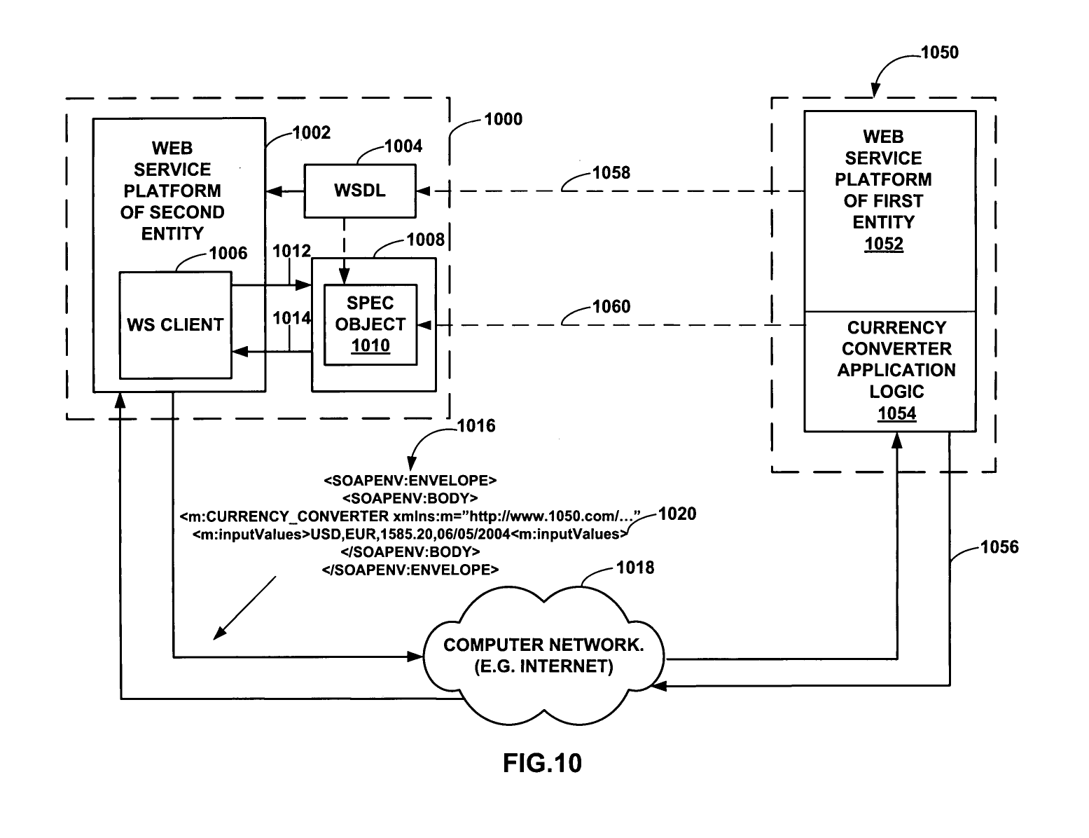

Referring now to FIG. 10, an exemplary block diagram of using specification object, in conjunction with a web service, A first entity 1050 provides application logic interface definition or WSDL 1004 to second entity 1000 and is represented by dotted line 1058. The first entity 1050 also provides a specification object 1010 corresponding to input data of currency converter application logic 1054. This is represented by dotted line 1060. Unlike prior-art WSDL, 1004 comprise reference to the specification object 1010. For example, input message section of WSDL 1004 may comprise unique identifier of specification object 1010. In prior-art WSDL, this section may correspond to reference to XML schema of input message. Specification object 1010 is loaded into a specification interface system 1008.

It should be noted that input SOAP request 1016 comprises final input data of currency converter application logic 1054. However, the first entity supplies exposed input data instance 1012 of currency converter application logic 1054 in accordance with input definition of specification object 1010. The specification object 1010 in conjunction with SIS 1008 creates generated input data instance 1014, which is sent as the final input data 1016 to the application logic 1054. In this example, the exposed input data instance 1012 comprises four data elements, namely, from currency, to currency, input amount and effective date. Private section of the specification object 1010 comprises first instructions to validate the exposed input data instance, including verification of valid combination of from and to currency codes. Second instructions in the private section take care of converting effective date from local date to universal date such as GMT. It also take care of combining four input data elements of exposed input data instance into one combined generated input data instance which is sent as final input data as represented in 1020.

Typically, web service platform 1002 has capability to generate a portion of source code from WSDL 1004 that may be used to build the web service client application 1006. According to this embodiment of present invention, an enhanced source code generator is provided in the web service platform 1002. The enhanced source code generator reads WSDL 1004 and generates first portion of the source code. Next, it reads the unique identifier of the specification object 1010 and generates second portion of the source code by reading the interface definition of the specification object 1010. The second portion of the source code comprises API calls to SIS 1008, verification of return status and the like. First portion of the source code and second portion is used to build client application 1006.

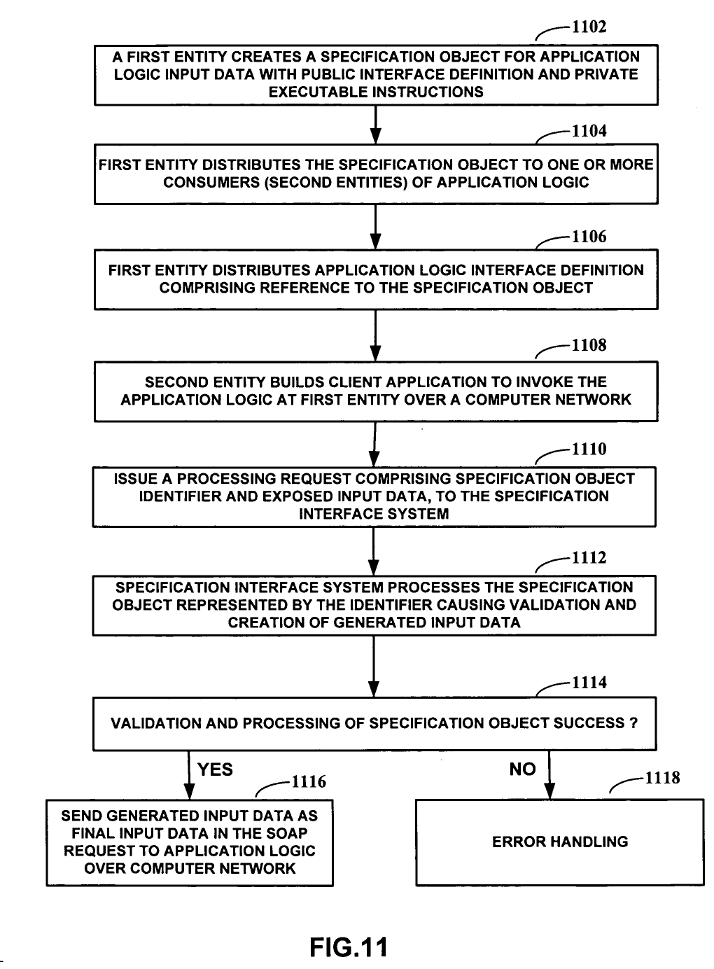

FIG. 11 depict a flow diagram of method of using a specification object in conjunction with a web service. At step 1102, a first entity creates the specification object corresponding to one or more input data parameter of the web service or application logic. At step 1104, the first entity distributes the specification object to one or more consumers (second entities). The first entity also distributes application logic interface definition such as WSDL to second entities at step 1106. The application logic interface definition comprises reference to the specification object. This may be by including unique identifier of the specification object in WSDL. At step 1108, the second entity builds a client application or program to invoke the application logic over a computer network. Portion of this program may be automatically generated from source code generator with WSDL as input. The source code generator may also generate client code to invoke specification interface system to execute the specification object referenced in the WSDL.

At step 1110, a processing request comprising instance of exposed input data and unique identifier of the specification object is sent to the specification interface system causing the execution of the specification object referenced in the WSDL. At step 1112, SIS processes the specification object causing creation of generated input data as described in earlier sections. Client code in web service platform receives status of processing back from SIS and at step 1116 check is made whether the status is success or failure. If the status is success, generated input data is sent as final input data to the application logic in SOAP request over the computer network. If the status is failure, processing flow is directed to error handling step 1118.

Having described and illustrated the principles of invention with reference to illustrative embodiments, it will be recognized that the illustrative embodiments can be modified in arrangement and detail without departing from such principles. It should be understood that the programs, processes, or methods described herein are not related or limited to any particular type of computing environment or programming language, unless indicated otherwise. Various types of general purpose or specialized computing environments may be used with or perform operations in accordance with the teachings described herein.

In view of the many possible embodiments to which the principles of current invention may be applied, I claim as my invention all such embodiments as may come within the scope and spirit of the following claims and equivalents thereto.

1) A computer-implemented method for generating a data document message by a second entity, wherein said data document message is electronically transferred from said second entity to a first entity over a computer network and said data document message complying to specifications of said first entity, the method comprising:
said first entity creating specification of the data document as a specification object, wherein said specification object is identified by a unique identifier, said specification object comprising:
interface definition comprising exposed input data definition and generated input data definition; and
a private section comprising first instructions for validation and second instructions for converting exposed input data instance to the generated input data instance;
said second entity receiving said specification object;
providing a specification interface system to said second entity, wherein said specification interface system comprising third instructions to handle incoming processing request from a first data processing system, wherein said processing request comprising said unique identifier and exposed input data instance, wherein said exposed input data instance conforming to said exposed input data definition;
said third instructions further comprising instructions to execute said specification object referenced by said unique identifier with said exposed input data instance causing creation of the generated input data instance in accordance with said generated input data definition, wherein said generated input data instance corresponds to at least a portion of said data document message; and
executing fourth instructions in the first data processing system causing the first data processing system to send the processing request to said specification interface system, which further causes said specification interface system to execute said specification object, resulting in execution of said first instructions and said second instructions with said exposed input data instance, and if the validation status is success, resulting in creation of said generated input data instance.

2) The computer-implemented method of claim 1, wherein said first data processing system comprising a specification interface client, wherein said specification interface client is used to interface said first data processing system with said specification interface system.

3) The computer-implemented method of claim 1, further comprising the steps of:
providing means to generate a record structure definition in the first data processing system format from said exposed input data definition; and
mapping a source data document to the record structure in the first data processing system and creating said exposed input data instance.

4) The computer-implemented method of claim 1, wherein said first data processing system is a middleware system.

5) The computer-implemented method of claim 1, wherein said interface definition is in XML schema format.

6) The computer-implemented method of claim 1, wherein said first and second instructions are in at least one of: an interpretable computer language, byte code representation and directly executable binary code representation.

7) The computer-implemented method of claim 1, wherein said specification object having one or more versions, wherein just one version is active at a time.

8) The computer-implemented method of claim 1, wherein said private section further comprising a private data section, wherein said private data section further comprising at least one of: data elements used by the instructions of said specification object and help data related to said specification object.

9) The computer-implemented method of claim 1, wherein said generated input data instance is in at least one of: extensible manipulation language (XML) format and electronic data interchange (EDI) standard format.

10) The computer-implemented method of claim 1, wherein said first instructions for validation comprising business rules associated with said data document message.

11) The computer-implemented method of claim 1, wherein said first entity generating a new version of said specification object whenever there is a change to specifications of the data document.

12) The computer-implemented method of claim 1, wherein said specification interface system further comprising a specification object builder for generating a second specification object corresponding to a second data document message.

13) The computer-implemented method of claim 1, wherein said specification interface system further comprising a specification object downloader for automatically checking for a new version of the specification object at a remote network site and, if the new version found, automatically downloading the specification object and notifying a user.

14) The computer-implemented method of claim 1, wherein said computer network is the Internet.

15) The computer-implemented method of claim 1, wherein said computer network is a value added network (VAN).

16) The computer-implemented method of claim 1, wherein said data document message is transferred to said first entity via an electronic marketplace.

17) The computer-implemented method of claim 1, wherein said specification object is physically represented by one or more computer files.

18) In a business-to-business electronic document transfer computing environment, a system used by a second entity for generating a data document message complying to specifications of a first entity wherein said data document message is transferred electronically to said first entity from said second entity over a computer network, and said second entity receiving a specification object corresponding to specifications of the data document, wherein said specification object is provided by said first entity, and said second entity using said system to execute said specification object to generate at least a portion of said data document message, in response to a processing request received from a first data processing system, wherein said processing request comprising an identifier that uniquely identifies said specification object and exposed input data instance, said system comprising:
at least one processor, memory and said specification object, wherein said specification object comprising:
interface definition comprising exposed input data definition and generated input data definition; and
a private section comprising first instructions for validation and second instructions for converting exposed input data instance to the generated input data instance; and,
third instructions residing in said memory, when executed by said processor causes the system to perform the steps of:
receiving said processing request and retrieving said specification object referenced by said identifier; and
executing instructions of said specification object on said processor resulting in validation of said exposed input data instance and if said validation is successful, further resulting in creation of a generated input data instance, wherein said generated input data instance corresponds to at least a portion of said data document message.

19) The system of claim 18 further comprising a record structure generator comprising instructions when executed by said processor generates a record structure definition of exposed input data definition of said specification object in a format of said first data processing system.

20) The system of claim 18 further comprising a specification object creation component comprising instructions when executed by said processor receives input from a user and creates a second specification object.

21) The system of claim 18 further comprising a user interface component comprising instructions, when executed by said processor displays the content of selected specification object.

22) The system of claim 18 further comprising a download manager configured to download one or more specification object from a remote site, wherein said download manager comprising instructions, when executed by said processor causes said system to perform the steps of:
checking for any modification to the version of specification object and if there are any changes, downloading new version of specification object and storing in said specification object repository; and
notifying a user of said system about said download.

23) The system of claim 18, wherein said specification object repository comprising one or more versions of same specification object, wherein one version of said specification object is active version.

24) The system of claim 21, wherein said user interface component further comprising instructions when executed by said processor accepts a specification object identifier and displays details of changes from one version to another.

25) A computer-implemented method for programmatically transferring at least one final input data to an application logic provided by a first entity, by a second entity over a computer network, the method comprising:
said first entity creating specification of the final input data as a specification object represented by a unique identifier, said specification object comprising:
interface definition comprising exposed input data definition and generated input data definition; and
private section comprising first instructions for validation and second instructions for converting the exposed input data instance to the generated input data instance; and
said second entity receiving said specification object;
providing a specification interface system to said second entity, wherein said specification interface system comprising third instructions to handle incoming processing request from a first data processing system, wherein said processing request comprising said unique identifier and at least one exposed input data instance, wherein said exposed input data instance conforming to said exposed input data definition;
said third instructions further comprising instructions to execute said specification object referenced by said unique identifier with said exposed input data instance causing creation of generated input data instance in accordance with said generated input data definition, wherein said generated input data instance is passed to said application logic as the final input data;
executing fourth instructions in the first data processing system causing the first data processing system to send said unique identifier and said exposed input data instance to said specification interface system, which further causes said specification interface system to execute said specification object, resulting in execution of said first instructions and said second instructions with said exposed input data instance, and if the validation status is success, resulting in generation of said generated input data instance; and
transferring said generated input data instance as final input data to said application logic over said computer network.

26) The computer-implemented method of claim 25 further comprising the step of providing application logic interface definition to said second entity, wherein said application logic interface definition is used to generate instructions to invoke said application logic.

27) The computer-implemented method of claim 26, wherein said application logic interface definition is in web service definition language (WSDL).

28) The computer-implemented method of claim 26, wherein said application logic interface definition comprising said unique identifier.

29) The computer-implemented method of claim 26, wherein said specification object is physically represented by one or more computer files.

30) The computer-implemented method of claim 26, wherein said application logic is exposed as a Web service.

31) The computer-implemented method of claim 26, wherein said computer network is the Internet.

32) The computer-implemented method of claim 26, wherein said interface definition is in XML schema format.
